(19) United States
(12) Patent Application Publication
(10) Pub. No.: US 2008/0111775 A1
(43) Pub. Date: May 15, 2008

(54) APPARATUS FOR CONTROLLING BRIGHTNESS OF DISPLAY USING DIFFRACTIVE OPTICAL MODULATOR

(75) Inventors: Kyu Bum Han, Yongin-si (KR); Sun Ki Kim, Suwon (KR); In Jae Yeo, Yongin-si (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/876,602

(22) Filed: Oct. 22, 2007

(30) Foreign Application Priority Data
Nov. 9, 2006 (KR) 1020060110644
Nov. 16, 2006 (KR) 1020060113367

(51) Int. Cl. G09G 3/30

(52) U.S. Cl. 345/77

(57) ABSTRACT

Disclosed herein is an apparatus for controlling brightness of a display device using a diffractive optical modulator. The apparatus includes a video signal reception unit, a video brightness type classification unit, and a brightness correction unit. The brightness correction unit corrects the brightness of the video based on the brightness type, determined by the video brightness type classification unit, and outputs information about the brightness of the video.

### CROSS REFERENCE TO RELATED APPLICATIONS

This application claims the benefit of Korean Patent Application No. 10-2006-0110644, filed on Nov. 9, 2006, entitled “Apparatus of Controlling Lightness for Display using Diffraction” and Korean Patent Application No. 10-2006-0113367, filed on Nov. 16, 2006, entitled “Apparatus of Controlling Power for Display using Diffraction,” which are hereby incorporated by reference in their entirety into this application.

### BACKGROUND OF THE INVENTION

1. Field of the Invention

The present invention relates generally to an apparatus for controlling the brightness of a display using a diffractive optical modulator and, more particularly, to an apparatus for controlling the brightness of a display using a diffractive optical modulator, which analyzes a histogram of each frame of video data, classifies the type of video according to the characteristics of the histogram, and performs type-based video data conversion based on the type of video, thereby increasing brightness.

2. Description of the Related Art

Recently, micromachining technology for manufacturing micro-optical parts, such as micromirrors, micro-lenses and micro-switches, micro-inertial sensors, micro-biochips, and micro-Radio Frequency (RF) communication elements using a semiconductor device manufacturing process has been developed.

Such micromirrors are used in various ways of statically and dynamically moving in vertical, diagonal and horizontal directions. The vertical movement of micromirrors is used for phase correctors and diffraction devices, the diagonal movement of micromirrors is used for scanners, switches, optical signal distributors, optical signals attenuators and light source arrays, and the horizontal movement of micromirrors is used for optical shielding devices, optical switches and optical signal distributors.

An example of such micromirrors is a reflective deformable grating optical modulator, which is disclosed in U.S. Pat. No. 5,311,160, issued to Broom et al.

Meanwhile, the above-described optical modulator has various applications. A consideration regarding such applications is the maintenance of uniform brightness. In particular, when the above-described optical modulator is used for a mobile terminal, it is important to maintain uniform brightness without high power consumption.

### SUMMARY OF THE INVENTION

Accordingly, the present invention has been made keeping in mind the above problems occurring in the prior art, and the present invention is intended to provide an apparatus for controlling the brightness of a display using a diffractive optical modulator, which analyzes a histogram of each frame of video data, classifies the type of video according to the characteristics of the analyzed histogram, and performs type-based video data conversion based on the type of video, thereby being capable of increasing the brightness of projected video without changing the output of light.

In addition, the present invention is intended to provide an apparatus for controlling the brightness of a display using a diffractive optical modulator, which increases the brightness of video in such a way as to analyze a histogram of video data for respective frames, classify the type of video according to the characteristics of the analyzed histogram, and perform type-based video data conversion based on the type of video, and then reduces the output of light by a value corresponding to the increased brightness, thereby being capable of reducing total power consumption.

The present invention provides an apparatus for controlling brightness of a display device using a diffractive optical modulator, including a video signal reception unit for receiving video from an outside; a video brightness type classification unit for acquiring the characteristics of brightness distribution of the video, received by the video signal reception unit, for respective frames, and determining a brightness type; and a brightness correction unit for correcting the brightness of the video based on the brightness type, determined by the video brightness type classification unit, and outputting information about the brightness of the video.

In addition, the present invention provides an apparatus for controlling brightness of a display device using a diffractive optical modulator, including a video signal reception unit for receiving video from an outside; a video brightness type classification unit for acquiring the characteristics of brightness distribution of the video, received by the video signal reception unit, for respective frames, and determining a brightness type; a brightness correction unit for correcting the brightness of the video based on the brightness type, determined by the video brightness type classification unit, and outputting information about the brightness of the video; a light source control unit for determining light output based on the brightness type classified by the video brightness type classification unit, and producing and outputting a control signal capable of producing the determined light output; and a light source drive circuit for controlling the light source control unit in response to the control signal output from the light source control unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of a display system using a diffractive optical modulator, which is applied to a mobile terminal, according to an embodiment of the present invention;

FIG. 2 is a block diagram of the projection control unit shown in FIG. 1;

FIG. 3 is a block diagram showing an apparatus for controlling brightness according to an embodiment of the present invention;

FIG. 4 is a flowchart showing a method of controlling brightness according to an embodiment of the present invention;

FIG. 5 is a table showing an example of the application current values stored in the application current value table of FIG. 3;

FIGS. 6A to 6E are graphs showing examples of video types that are used in the present invention; and

FIG. 7 is a graph for the determination of type-based multiplication factors that are used to obtain reference data to be stored in the correction data reference unit of FIG. 3.

### DESCRIPTION OF THE PREFERRED EMBODIMENTS

Reference now should be made to the drawings, in which the same reference numerals are used throughout the different drawings to designate the same or similar components.

Embodiments of the present invention are described in detail below with reference to the accompanying drawings.

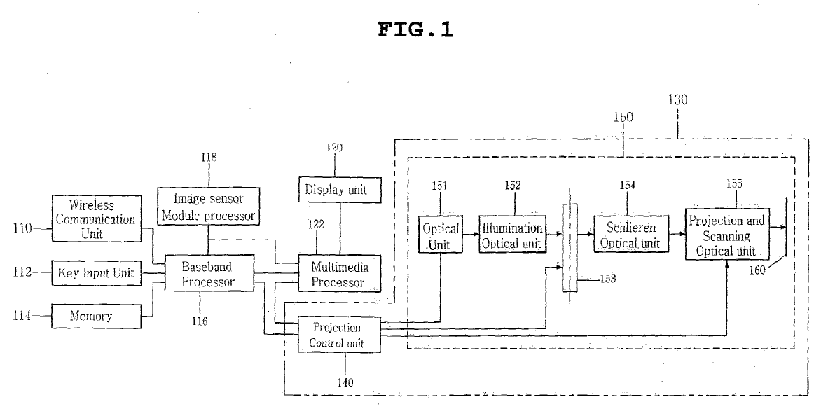

FIG. 1 is a block diagram of a display system using a diffractive optical modulator, which is applied to a mobile terminal, according to an embodiment of the present invention.

Referring to FIG. 1, the display system using a diffractive optical modulator, which is applied to a mobile terminal, according to the embodiment of the present invention, includes a radio communication unit 110, a key input unit 112, memory 114, a baseband processor 116, an image sensor module processor 118, a display unit 120, a multimedia processor 122 and a optical modulator projector 130.

The radio communication unit 110 wirelessly communicates with an external system, the key input unit 112 receives information outside the present system, and the memory 114 stores data such as video data.

The baseband processor 116 and the multimedia processor 122 allow video to be displayed on the display unit 120, or direct the projection control unit 140 of the optical modulator projector 130, that is, a display system using a single panel-type diffractive optical modulator, to project video onto a screen 160.

The image sensor module processor 118 processes video input from a camera or the like, and sends the processed video data to the baseband processor 116 or the multimedia processor 122.

The display unit 120 displays the video data, supplied from the baseband processor 116, on a screen.

Under the control of the baseband processor 116, the optical modulator projector 130 produces video using the single panel-type diffractive optical modulator based on the video data input from the baseband processor 116, magnifies the produced video, and then projects the enlarged video onto the screen 160. The optical modulator projector 130 includes a projection control unit 140 and an optical modulation system 150.

The projection control unit 140 directs the optical modulation system 150 to produce video based on the video data, input from the multimedia processor 122, in response to control signals from the baseband processor 116.

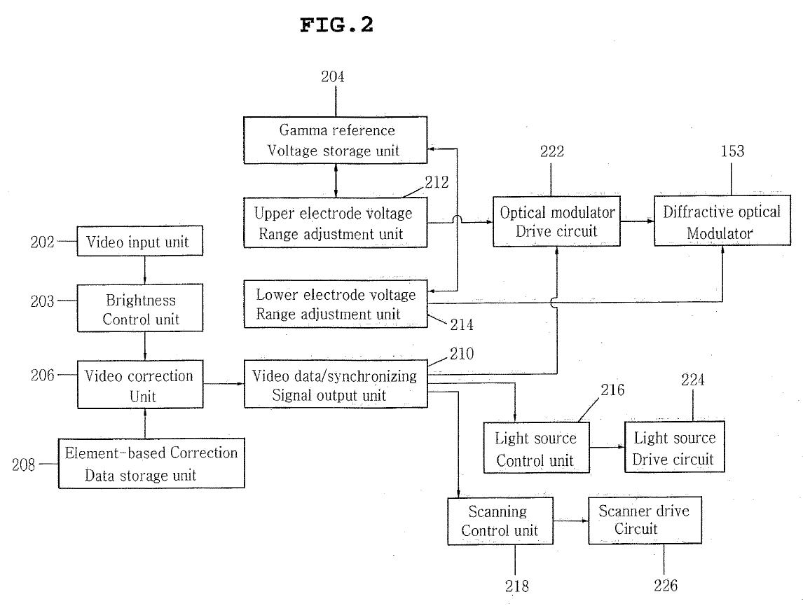

The projection control unit 140, as shown in FIG. 2, includes a video input unit 202, a brightness control unit 203, a gamma reference voltage storage unit 204, a video correction unit 206, a pixel-based correction data storage unit 208, an video data/synchronizing signal output unit 210, an upper electrode voltage range adjusting unit 212, a lower electrode voltage range adjusting unit 214, a light source control unit 216, a scanning control unit 218, an optical modulator drive circuit 222, a light source drive circuit 224, and a scanner drive circuit 226. Here, the brightness control unit 203, the light source control unit 216, and the light source drive circuit 224 constitute a brightness control device. A detailed description of the projection control unit 140 will be given later.

In response to control signals from the projection control unit 140, the optical modulation system 150 produces video, magnifies the produced video, and then projects the magnified video onto the screen 160. The optical modulation system 150 includes a light source unit 151, an illumination optical unit 152, a diffractive optical modulator 153, a Schlieren optical unit 154, and a projection and scanning optical unit 155.

The light source unit 151 produces and emits red light R, green light G and blue light B in response to light source switching control signals from the projection control unit 140, and the illumination optical unit 152 causes light, emitted by the light source unit 151, to be incident on the diffractive optical modulator 153.

The diffractive optical modulator 153 produces video by diffracting light incident from the illumination optical unit 152 in response to video data signals, reference voltage, lower electrode voltage, a vertical synchronizing signal and a horizontal synchronizing signal from the projection control unit 140 (that is, the illumination optical unit 152 produces diffracted light having a plurality of diffraction orders by diffracting incident light, in which case diffracted light having one or more desired diffraction orders, selected from among a plurality of diffraction orders of the diffracted light, forms the video).

The Schlieren optical unit 154 passes diffracted light having one or more desired diffraction orders, selected from among the plurality of diffraction orders of the diffracted light generated by the diffractive optical modulator 153, therethrough.

The projection and scanning optical unit 155 projects video, formed by the diffracted light passed through the Schlieren optical unit 154, onto the screen 160.

FIG. 2 is a diagram showing the construction of a projection control unit equipped with a brightness control device according to an embodiment of the present invention. Since the construction thereof has been described above, the operation thereof is described below.

The video input unit 202 performs an interface function between the light modulation optical system 150 and a mobile terminal control system.

The video input unit 202 of the projection control unit 140 receives video data from the multimedia processor 122, and, at the same time, receives a vertical synchronizing signal Vsync and a horizontal synchronizing signal Hsync.

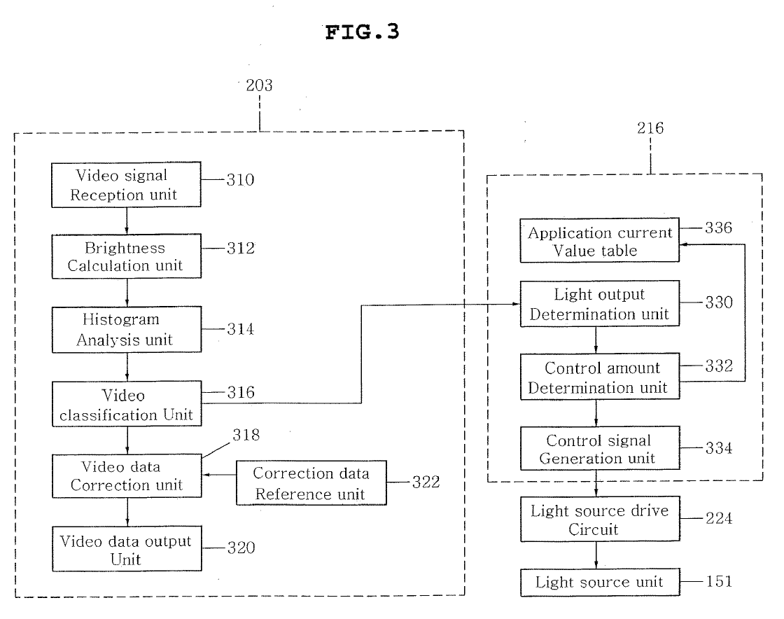

Meanwhile, the brightness control unit 203 of the projection control unit 140 analyzes each frame of video, input to the video input unit 202, using a histogram based on the distribution characteristics of brightness, classifies the type of video according to the characteristics of the analyzed histogram, and performs video data conversion based on the classified type, thereby increasing the brightness of the video. The brightness control unit 203 sends information about the type of video, classified for each frame, to the light source control unit 216. The brightness control unit 203 will be separately described in detail with reference to FIG. 3 later.

Thereafter, the video correction unit 206 of the projection control unit 140 converts laterally input video data into vertically arranged video data by performing a data transposition or video pivoting process of laterally arranged video data into vertically arranged data, and outputs the vertically arranged data. The reason why the video correction unit 206 requires data transposition is that a scan line, emitted from the diffractive optical modulator 153, is configured such that it is scanned and displayed in a lateral direction because a plurality of diffracted light spots corresponding to a plurality of pixels (for example, 480 pixels in the case where the number of pieces of input video data is 480*640) is arranged in a vertical direction.

Meanwhile, the gamma reference voltage storage unit 204 stores an upper electrode (gamma) reference voltage and a lower electrode (gamma) reference voltage. Here, the “upper electrode (gamma) reference voltage” means an upper electrode reference voltage that is referred to when the optical modulator drive circuit 222 of the diffractive optical modulator 153 outputs application voltages for respective elements according to the gray levels of video data, and the “lower electrode reference voltage” means a voltage that is applied to the lower electrode of the diffractive optical modulator 153.

The reason why the upper electrode reference voltage and the lower electrode reference voltage are stored in the gamma reference voltage storage unit 204 and are referred to by the optical modulator drive circuit 222 of the diffractive optical modulator 153 when the optical modulator drive circuit 222 of the diffractive optical modulator 153 outputs application voltages according to gray levels is that the intensity of diffracted light, emitted from the diffractive optical modulator 153, exhibits a gamma characteristic in which it does not vary linearly with the level of an applied voltage, but varies nonlinearly.

In this situation, when a gray level of video data is input from the video data/synchronizing signal output unit 210, the optical modulator drive circuit 222 acquires an upper electrode voltage corresponding to the gray level with reference to the upper electrode reference voltage, provided through the upper electrode voltage range adjusting unit 212, so as to acquire the upper electrode voltage that matches the gray level. At this time, the upper electrode voltage range adjusting unit 212 reads the upper electrode reference voltage from the gamma reference voltage storage unit 204, and outputs the read upper electrode reference voltage to the optical modulator drive circuit 222. At the same time, the lower electrode voltage is provided to the diffractive optical modulator 153 by the lower electrode voltage adjusting unit 214. That is, the lower electrode voltage adjusting unit 214 reads the lower electrode reference voltage from the gamma reference voltage storage unit 204, and provides it to the lower electrode of the diffractive optical modulator 153.

Accordingly, the diffractive optical modulator 153 is driven in response to the upper electrode voltage provided by the optical modulator drive circuit 222 and the lower electrode voltage provided by the lower electrode voltage adjusting unit 214, and produces diffracted light by modulating incident light.

Meanwhile, the element-based correction data stored in the element-based correction data calculation unit 208 is referred to when the video correction unit 206 produces corrected video data by correcting video data from the brightness control unit 203, and may be arranged in a table.

The video data/synchronizing signal output unit 210 provides video data, output from the video correction unit 206, to the optical modulator drive circuit 222.

The video data/synchronizing signal output unit 210 receives a vertical synchronizing signal and a horizontal synchronizing signal from the video correction unit 206 and outputs them.

Meanwhile, when the vertical synchronizing signal and the horizontal synchronizing signal are received from the video data/synchronizing signal output unit 210, the light source control unit 216 directs the light source drive circuit 224 to switch the light source. Furthermore, when information about a frame-based video type is received from the brightness control unit 203, the light source control unit 216 determines a reduction in light output corresponding to the type, determines a current value, to be applied to the light source unit 151, corresponding to the determined reduction, and provides a control signal, corresponding to the determined current value, to the light source drive circuit 224. Then, the light source drive circuit 224 reduces a current, to be applied to the light source control unit 216, in response to a control unit from the light source control unit 216.

Meanwhile, when a vertical synchronizing signal and a horizontal synchronizing signal are received from the input video data/synchronizing signal output unit 210, the scanning control unit 218 directs the scanner drive circuit 226 to drive the scanner (not shown) of the projection and scanning optical unit 155.

Meanwhile, when information about a video data gray level is received from the video data/synchronizing signal output unit 210, the optical modulator drive circuit 222 produces a drive voltage for the upper electrode with reference to the upper electrode reference voltage provided by the upper electrode voltage range adjusting unit 212, and outputs the drive voltage to the diffractive optical modulator 153.

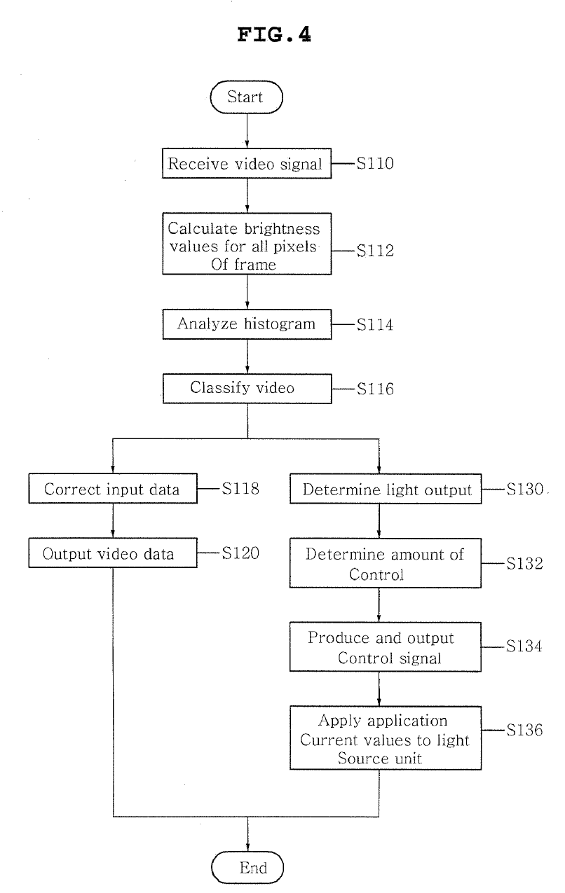

FIG. 3 is a block diagram showing an apparatus for controlling brightness according to an embodiment of the present invention, and FIG. 4 is a flowchart showing a method of controlling brightness according to an embodiment of the present invention.

Referring to FIG. 3, the apparatus for controlling brightness according to an embodiment of the present invention includes a brightness control unit 203, a light source control unit 216, and a light source drive circuit 224.

The brightness control unit 203 includes a video signal reception unit 310, a brightness calculation unit 312, a histogram analysis unit 314, a video classification unit 316, a video data correction unit 318, a video data output unit 320, and a correction data reference unit 322.

The light source control unit 216 includes a light output determination unit 330, a control amount determination unit 332, a control signal generation unit 334, and an application current value table 336.

Here, the brightness calculation unit 312, the histogram analysis unit 314 and the video classification unit 316 may be collectively referred to as a “video brightness-type classification unit,” while the video data correction unit 318, the video data output unit 320 and the correction data reference unit 322 may be collectively referred to as a “brightness correction unit.”

In this case, the video signal reception unit 310 receives Red/Green/Blue (R/G/B) video data from the video input unit 202.

Meanwhile, the brightness calculation unit 312 converts the R/G/B video data, received by the video signal reception unit 310, into gray video data that is represented by brightness.

Thereafter, the histogram analysis unit 314 creates a histogram for one frame of video based on pixel-based brightness values that are calculated by the brightness calculation unit 312.

The video classification unit 316 analyzes the shape of the histogram, and detects the type of analyzed histogram. The video classification unit 316 notifies the light output determination unit 330 of the light source control unit 216 of the type of histogram that is detected by analyzing the shape of the diagram.

Meanwhile, the correction data reference unit 322 stores multiplication factor data that is used to obtain a corrected output gray level for each type-based input gray level.

The video data correction unit 318 performs correction with reference to multiplication factor data that is stored in the correction data reference unit 322 and corresponds to the type detected by the video classification unit 316.

Thereafter, the video data output unit 320 outputs video data corrected by the video data correction unit 318.

Meanwhile, when information about the type of histogram is received from the video classification unit 316, the light output determination unit 330 determines a reduction in light output corresponding to the input information about the type of histogram.

The control amount determination unit 332 determines and outputs a current value to be applied to the light source according to the reduction determined by the light output determination unit 330, with reference to the application current value table 336.

In this case, the application current value table 336 contains application current value indices based on the percentages of brightness, and contains application current value indices based on the percentages of brightness for each of an R light source, a G light source G and a B light source.

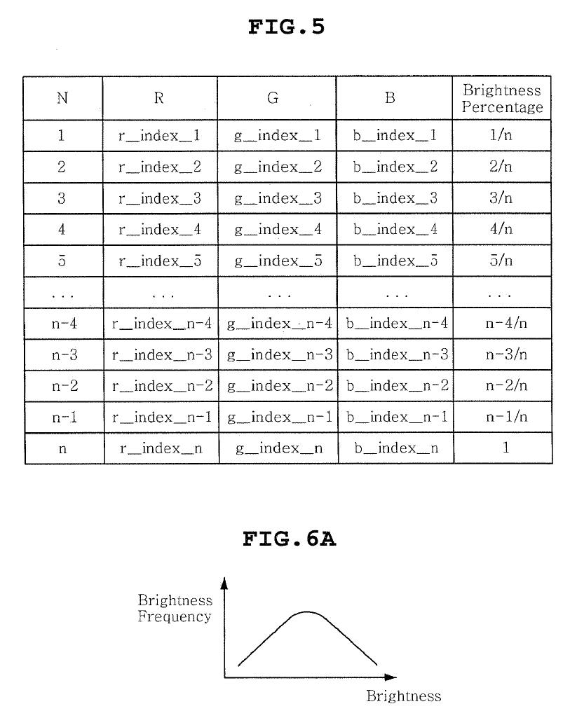

For example, when the percentage of brightness is set to 1 (that is, 100%), an application current value table based on the percentages of brightness, stored in the application current value table 336 shown in FIG. 5, contains application current value indices “r_index n” for the R light source, contains application current value indices g_index n for the G light source, and contains application current value indices b_index_n for the B light source. Furthermore, when the percentage of brightness of 1 is divided by n, the application current value table 336 contains application current value indices for the R light source, application current value indices for the G light source, and application current value indices for the R light source. As an example, when the percentage of brightness is set to n−4/n, the application current value table 336 contains application current value indices r_index_n−4 for the R light source, contains application current indices g_index_n−4 for the G light source, and contains application current value indices b_index_n−4 for the B light source.

The control amount determination unit 332 reads an application current value index based on the reduction in light output, determined by the light output determination unit 330, from the application current value table 336, and outputs the read application current value index.

The control signal generation unit 334 produces a control signal of the light source control unit 151 based on the application current value index determined by the control amount determination unit 332, and outputs the produced control signal to the light source control unit 151.

Now, referring to FIGS. 3 and 4, the operation of the apparatus for controlling brightness according to an embodiment of the present invention is described in detail below.

First, the video signal reception unit 310 receives R/G/B video data from the video input unit 202 at step S110.

Thereafter, the brightness calculation unit 312 calculates brightness for each of the pixels of a frame of R/G/B video data at step S112.

As an example, assuming that the gray level of the R video data of a specific pixel is r, the gray level of G video data is g, the gray level of B video data is b and the brightness of the pixel is L, L=═*r+β*g+γ*b. In this case, the sequence of contribution of video data to brightness is G>R>B video data, so that weights α, β, and γ, by which respective pieces of video data are multiplied, are determined in the sequence of β>α>α.

When the brightness calculation unit 312 calculates brightness for each of the pixels constituting video data received by the video signal reception unit 310, and outputs the calculated brightness, as described above, the histogram analysis unit 314 draws a brightness histogram each frame at step S114.

That is, the brightness calculation unit 312 calculates brightness for each of pixels constituting each frame of video data, and outputs the calculated brightness.

Then, the histogram analysis unit 314 draws a brightness histogram for each frame using all brightness values for all the pixels of the frame (the number of all pixels=vertical resolution*horizontal resolution), with one axis being set to a brightness axis and the other axis being set to a frequency axis.

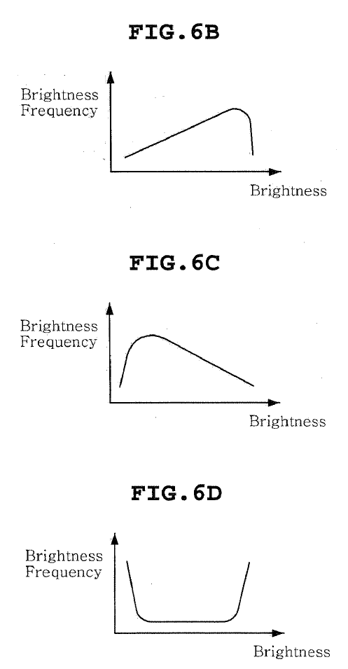

In this case, the brightness histogram obtained by the histogram analysis unit 314 may be an intermediate gray level distribution type (FIG. 6A), a higher gray level distribution type (FIG. 6B), a lower gray level distribution type (FIG. 6C), a higher and lower gray level distribution type (FIG. 6D), and a full, uniform gray level distribution type (FIG. 6E), as illustrated in the examples of FIGS. 6A to 6E. Here, the intermediate gray level distribution type is related with a video frame containing many intermediate brightness values, the higher gray level distribution type is related with a video frame containing many highest brightness values, the lower gray level distribution type is related with a video frame containing dark pixel video, a higher and lower gray level distribution type is related with a video frame in which bright portions and dark portions are clearly distinguished from each other, and the a full, uniform gray level distribution type is related with a video frame having brightness values.

When the histogram analysis unit 314 has drawn a histogram, as described above, the video classification unit 316 determines the type of the histogram, outputs information about the determined type to the video data correction unit 318, and outputs the information to the light output determination unit 330 of the light source control unit 216 at step S116.

Meanwhile, the correction data reference unit 322 stores multiplication factors based gray levels depending on the types of gray level versus brightness graphs.

Here, respective type-based multiplication factors are determined through experiments. They are determined such that, when gray levels are corrected by multiplying the gray levels by multiplication factors, an average gray level is increased, and thus the brightness characteristics of a display are improved.

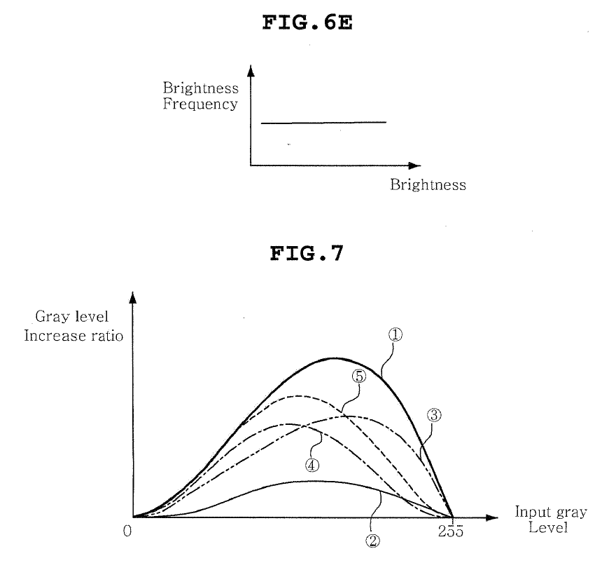

Examples thereof are shown in FIG. 7. Graph \textcircled{1} of FIG. 7 is a multiplication factor graph for the intermediate gray level distribution type. In the case of the intermediate gray level distribution type, since there are many intermediate brightness values, brightness characteristics are considerably improved by further increasing intermediate brightness values, so that the graph is configured such that the intermediate values are multiplied.

Graph \textcircled{2} of FIG. 7 is a multiplication factor graph for the higher gray level distribution type. In the case of this type, since brightness characteristics are entirely excellent, it is not necessary to improve brightness characteristics highly, so that a graph containing low values is illustrated.

Graph \textcircled{3} of FIG. 7 is a multiplication factor graph for the lower gray level distribution type. In the case of this type, even though a great multiplication factor is required to improve brightness characteristics because a related video frame includes entirely dark video, an appropriate multiplication factor value is selected in view of the mood of video because the original frame is dark video.

Graph \textcircled{4} of FIG. 7 is a multiplication factor graph for the higher and lower gray level distribution type. In the case of this type, higher gray level video and lower gray level video are clearly distinguished from each other, so that no change in video occurs even if intermediate gray level values are highly multiplied, with the result that a higher multiplication factor is applied to intermediate gray level values.

Graph \textcircled{5} of FIG. 7 is a multiplication factor graph for the full, uniform gray level distribution type. Even if lower gray levels are multiplied by a higher multiplication factor, there is no great change in video, so that such this graph is configured as shown in FIG. 7.

Here, the correction data reference unit 322 stores multiplication factors determined for respective gray levels. That is, the correction data reference unit 322 stores multiplication factors that are obtained by obtaining, for example, a quartic equation through numerical analyses of the graphs of FIG. 7 and calculating the multiplication factors for respective gray levels.

The correction data reference unit 322 stores type-based multiplication factors determined for respective gray levels, as described above. Accordingly, when receiving information about the type of video from the video classification unit 316, the video data correction unit 318 corrects input video data with reference to the type-based gray level versus multiplication factor values stored in the correction data reference unit 322, and outputs the corrected input data at step S118.

As an example, when the type of video determined by the video classification unit 316 is the lower gray level distribution type and the input video gray level is 100, R/G/B video data is multiplied by a multiplication factor with reference to the multiplication factor of graph \textcircled{3} of FIG. 7 for gray level 100, which are stored in the correction data reference unit 322, and the multiplied video data is output. When the multiplication factor of graph \textcircled{3} for input video gray level 100 is LUT3 100, input video is Rin, Gin and Bin, output video is Rout, Gout and Bout, Rout=LUT3(100)*Rin, Gout=LUT3(100)*Gin and Bout=LUT3(100)*Bin are obtained.

Meanwhile, when the gray level of input video is determined, the greatest of the R/G/B data of the input video data may be used as a reference, or the gray level of G video data that most significantly affects gray level brightness may be used as a reference.

Meanwhile, when information about the type of a histogram is input from the video classification unit 316, the light output determination unit 330 determines a reduction in light output corresponding to the information about the type of a histogram at step S130.

For example, when the type of a histogram input from the video classification unit 316 is the intermediate gray level distribution type, the light output determination unit 330 may set a reduction in light output to 30% because brightness characteristics have been considerably improved. In the case of the higher gray level distribution type, the reduction may be set to 0% because brightness characteristics have been little improved. In the case of the lower gray level distribution type, the reduction may be set to 20% because brightness characteristics have been greatly improved. In the case of the higher and lower gray level distribution type, the reduction may be set to 10% because brightness characteristics have been somewhat improved. In the case of the full, uniform gray level distribution type, the reduction may be set to 5% because brightness characteristics have been a little improved.

When the light output determination unit 330 determines the reduction in light output based on the type of a histogram input from the video classification unit 316, as described above, the control amount determination unit 332 determines a value, obtained by subtracting the reduction in light output in the case where the brightness of the output of the light source is set to 100%, the amount of light output, reads an application current index having a brightness percentage, corresponding to the determined value, from the application current value table 336, and outputs the application current index at step S132. That is, as an example, in the case where a reduction in light output input from the light output determination unit 330 is 30%, the control amount determination unit 332 sets the amount of light output to 70%, reads a corresponding application current value index from the application current value table 336, and outputs the application current value index.

Then, the control signal generation unit 334 produces a control signal for directing the light source drive circuit 224 to apply application current based on an application current value index, determined by the control amount determination unit 332, to the light source control unit 151, and outputs the control signal to the light source drive circuit 224 at step S134.

Accordingly, the light source drive circuit 224 controls the light source control unit 151 by outputting current values to the R light source, the G light source, and the B light source in response to the control signal produced by the control signal generation unit 334 at step S136.

As described above, according to the present invention, there is an advantage in that the brightness characteristics of projected video are improved by increasing the average gray level of video through video data processing in a situation in which the output characteristics of light sources and the efficiency of an optical modulator and an optical system are fixed, as shown in FIG. 7.

FIG. 7 shows variations in the gray level for respective video types, and indicates that brightness values are generally increased.

Furthermore, according to the present invention, there is an advantage in that the average gray level of video is increased through video data processing, so that brightness characteristics are improved and the amount of output of light sources is reduced correspondingly, thereby reducing power consumption.

Moreover, according to the present invention, there is an advantage in that power consumption can be reduced due to a reduction in the amount of output of the light sources, so that, a mobile terminal is equipped with a display device using a diffractive optical modulator, and thus the mobile phone can be used for a long time without being charged.

That is, according to the present invention, power consumption is reduced due to a reduction in the amount of the output of the light sources, so that a mobile terminal can be used for a long time without charging in the case where the mobile terminal is equipped with the display, thereby increasing a user's convenience.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for controlling brightness of a display device using a diffractive optical modulator, comprising:
a video signal reception unit for receiving video from an outside;
a video brightness type classification unit for acquiring characteristics of brightness distribution of the video, received by the video signal reception unit, for respective frames, and determining a brightness type; and
a brightness correction unit for correcting brightness of the video based on the brightness type, determined by the video brightness type classification unit, and outputting information about the brightness of the video.

2. The apparatus as set forth in claim 1, wherein the video brightness type classification unit comprises:
a brightness calculation unit for acquiring brightness of respective pixels constituting each frame of the video received by the video signal reception unit;
a histogram analysis unit for constructing a histogram of the video frame using the brightness of the pixels acquired by the brightness calculation unit; and
a video classification unit for determining a type of video frame with reference to the histogram constructed by the histogram analysis unit.

3. The apparatus as set forth in claim 2, wherein the brightness calculation unit sets a value, obtained by multiplying R video data, G video data and B video data of the corresponding pixel, received by the video signal reception unit, by different weights and adding results of the multiplication, to a brightness value when acquiring the brightness of each pixel.

4. The apparatus as set forth in claim 2, wherein the brightness type classified by the video classification unit is one of an intermediate gray level distribution type, a higher gray level distribution type, a lower gray level distribution type, a higher and lower gray level distribution type, and a full, uniform gray level distribution type.

5. The apparatus as set forth in claim 1, wherein the brightness correction unit comprises:
a correction data reference unit for storing multiplication factors for gray levels based on each brightness type;
a video data correction unit for correcting the video frame by multiplying the video data by a multiplication factor while referring to the correction data reference unit for the multiplication factor based on the brightness type determined by the video brightness type classification unit; and
a video data output unit for outputting the video frame data corrected by the video data correction unit.

6. The apparatus as set forth in claim 5, wherein the brightness type is one of an intermediate gray level distribution type, a higher gray level distribution type, a lower gray level distribution type, a higher and lower gray level distribution type, and a full, uniform gray level distribution type.

7. The apparatus as set forth in claim 5, wherein the correction data reference unit, when referring to the correction data reference unit for the multiplication factor based on the brightness type classified by the video data correction unit, refers to the correction data reference unit for a multiplication factor of a corresponding gray level using G video data of the input video as a representative value.

8. The apparatus as set forth in claim 5, wherein the video data correction unit, when referring to the correction data reference unit for the multiplication factor based on the brightness type classified by the video brightness type classification unit, refers to the correction data reference unit for the multiplication factor for a corresponding gray level using a highest value of G video data, R video data and B video data of the input video as a representative value.

9. The apparatus as set forth in claim 5, wherein the video data correction unit refers to the correction data reference unit for a multiplication factor based on the brightness type classified by the video brightness type classification unit, and acquiring correction data by multiplying R video data, G video data and B video data of the input video by the multiplication factor.

10. An apparatus for controlling brightness of a display device using a diffractive optical modulator, comprising:
a video signal reception unit for receiving video from an outside;
a video brightness type classification unit for acquiring characteristics of brightness distribution of the video, received by the video signal reception unit, for respective frames, and determining a brightness type;
a brightness correction unit for correcting brightness of the video based on the brightness type, determined by the video brightness type classification unit, and outputting information about the brightness of the video;
a light source control unit for determining light output based on the brightness type classified by the video brightness type classification unit, and producing and outputting a control signal capable of producing the determined light output; and
a light source drive circuit for controlling the light source control unit in response to the control signal output from the light source control unit.

11. The apparatus as set forth in claim 10, wherein the video brightness type classification unit comprises:
a brightness calculation unit for acquiring brightness of respective pixels constituting each frame of the video received by the video signal reception unit;
a histogram analysis unit for constructing a histogram of the video frame using the brightness of respective pixels acquired by the brightness calculation unit; and
a video classification unit for determining a type of video frame with reference to the histogram constructed by the histogram analysis unit, and outputting information about the type of brightness to the brightness correction unit and the light source control unit.

12. The apparatus as set forth in claim 11, wherein the brightness type classified by the video classification unit is one of an intermediate gray level distribution type, a higher gray level distribution type, a lower gray level distribution type, a higher and lower gray level distribution type, and a full, uniform gray level distribution type.

13. The apparatus as set forth in claim 10, wherein the brightness correction unit comprises:
a correction data reference unit for storing multiplication factors for gray levels based on each brightness type;
a video data correction unit for correcting the video frame by multiplying the video data by a multiplication factor while referring to the correction data reference unit for the multiplication factor based on the brightness type determined by the video brightness type classification unit; and
a video data output unit for outputting the video frame data corrected by the video data correction unit.

14. The apparatus as set forth in claim 13, wherein the brightness type is one of an intermediate gray level distribution type, a higher gray level distribution type, a lower gray level distribution type, a higher and lower gray level distribution type, and a full, uniform gray level distribution type.

15. The apparatus as set forth in claim 10, wherein the light source control unit comprises:
an application current value table for storing indices of application current values based on each percentage of brightness;
a light output determination unit for, when receiving information about the brightness type from the brightness type classification unit, determining and outputting an amount of light output based on the brightness type;
a control amount determination unit for reading an application current value based on the amount of light output, determined by the light output determination unit, from the application current value table, and outputting the application current value; and
a control signal generation unit for producing a control signal based on the application current value input from the control amount determination unit, and outputting the control signal to the light source drive circuit.

16. The apparatus as set forth in claim 15, wherein:
the application current value table stores indices of application current values based on each percentage of brightness for respective light sources; and
the control amount determination unit reads application current values based on the amount of light output, determined by the light output determination unit, for the respective light sources from the application current value table, and outputting the application current values.

17. The apparatus as set forth in claim 16, wherein the brightness type is one of an intermediate gray level distribution type, a higher gray level distribution type, a lower gray level distribution type, a higher and lower gray level distribution type, and a full, uniform gray level distribution type.
